(19) United States
(12) Patent Application Publication
(10) Pub. No.: US 2021/0213316 A1
(43) Pub. Date: Jul. 15, 2021

(54) FIRE EXTINGUISHING SYSTEM WITH IMMEDIATE FIRE EXTINGUISHER AND METHOD USING THE SAME

(71) Applicant: Sua CHOI, Gyeonggi-do (KR)

(72) Inventor: Sua CHOI, Gyeonggi-do (KR)

(21) Appl. No.: 16/826,690

(22) Filed: Mar. 23, 2020

(30) Foreign Application Priority Data
Jan. 9, 2020 (KR) 10-2020-0003330

(51) Int. Cl. A62C 37/44; A62C 35/10; A62C 3/16

(52) U.S. Cl. CPC A62C 37/44; A62C 3/16; A62C 35/10

(57) ABSTRACT

A fire extinguishing system with an immediate fire extinguisher includes a wide area fire extinguishing system configured to have a main control system, a fire detecting unit connected to the main control system, a communication unit, and a wide-fire extinguishing unit that extinguishes a wide-spread fire in response to an instruction from the main control system, and a spot-fire extinguishing system configured to have an RF communication module as a third communication module for communicating with the main control system, a temperature sensor, and the immediate fire extinguisher that performs immediate extinguishing of a fire.

### CROSS-REFERENCE TO RELATED APPLICATION AND CLAIM OF PRIORITY

The present application claims the benefit of Korean Patent Application No. 10-2020-0003330 filed on Jan. 9, 2020 at the Korean Intellectual Property Office (KIPO), the entire disclosures of which are incorporated by reference herein in their entirety.

### BACKGROUND

### 1. Field of the Invention

The present invention relates to a fire extinguishing system, particularly, to a fire extinguishing system with an immediate fire extinguisher and a method using the fire extinguishing system that is capable of immediately extinguishing a small-scale flame which can occur due to an electrical short circuit in an electric switchboard or a power socket, for example, and that has a function of immediately notifying a user and a fire station of the flame.

### 2. Background Art

Usually, examples of fire factors include an electrical factor, a factor caused by a burner such as a heater or cooking utensil, or the like, but the electrical factor is often the major fire factor.

In particular, a fire caused by the electrical factor often occurs due to an electrical short, that is, electrical short circuit, in a switchboard, a panelboard, a server rack, a fuse box, a power strip, a ventilation fan, or an outdoor unit. A lot of dust accumulates inside the switchboard, the panelboard, the server rack, the fuse box, the ventilation fan, or the outdoor unit by the surroundings, and the dust catches small flame from small electrical sparks. Then, the flame gradually develops into a large flame, and a fire occurs. Besides, there is a high probability of a fire due to high electrical resistance with loose electrical contact in the power strip.

As described above, in a case of a fire due to not only the electrical factor but also other factors, many fire alarms that detect and notify the occurrence of fire are disclosed.

The fire alarms disclosed in prior art focus on contacting a user to warn about a fire via wired and wireless communication. Since the fire alarms disclosed in prior art simply notify the user of only the occurrence of fire, it is difficult for the user to know a scale of the fire or a degree of fire progress. As a result, only when the user approaches a fire site, it is possible for the user to know a condition of the fire.

In addition, a physical apparatus such as a sprinkler is known as an apparatus that puts out a fire when the fire occurs; however, the apparatus operates when a large fire occurs, and while the apparatus can successfully put out the fire itself, water splashed from the sprinkler may permanently damage equipment present in fire such as an electric or electronic apparatus which is vulnerable to water. In addition, the sprinkler operates after the fire develops into a relatively large-scale fire, and thus the sprinkler is an apparatus that is useful to put out the fire itself but is not effective for putting out a small-scale fire.

### SUMMARY

Hence, the invention is made to solve above-described disadvantages of the prior art, and an aspect thereof is to provide a fire extinguishing system with an immediate fire extinguisher in which a wide-fire alarm system that is capable of performing telephone and internet communication and RF wireless communication is installed at a site that needs to be protected from a fire, the immediate fire extinguisher and an RF wireless communication terminal are installed in a small-sized electric instrument installed in the wide-fire alarm system, initial putting-out of a small-scale fire is performed by the immediate fire extinguisher and primary notification of the occurrence of the fire to a user is simultaneously performed when the small-scale fire occurs in the electric instrument, and notification to the user and a fire station is performed and a fire extinguishing device of the wide-area fire alarm system is simultaneously operated in a case of determining that the fire is not completely put out after a predetermined time elapses, and a method using the fire extinguishing system.

In order to achieve one or more aspects of the invention, a fire extinguishing system with an immediate fire extinguisher according to the invention includes: a wide area fire extinguishing system configured to have a main control system, a fire detecting unit connected to the main control system, a communication unit, and a wide-fire extinguishing unit that extinguishes a wide-spread fire in response to an instruction from the main control system; and a spot-fire extinguishing system configured to have an RF communication module as a third communication module for communicating with the main control system, a temperature sensor, and the immediate fire extinguisher that performs immediate extinguishing of a fire.

In the fire extinguishing system with an immediate fire extinguisher according to the invention, the wide-fire extinguishing unit may be a sprinkler.

In the fire extinguishing system with an immediate fire extinguisher according to the invention, the main control system may have a central processing unit that manages the entire fire extinguishing system, a telephone communication and internet communication module as a first communication module for communicating with the outside, and an RF module as a second communication module for communicating with the third communication module of the spot-fire extinguishing system.

In the fire extinguishing system with an immediate fire extinguisher according to the invention, the wide-fire extinguishing unit may have a sprinkler or a gas fire extinguisher, and the fire detecting unit may have a temperature sensor and a smoke sensor.

In the fire extinguishing system with an immediate fire extinguisher according to the invention, the spot-fire extinguishing system may be formed in a sheet-shaped patch and may be made of a micro-encapsulated fire extinguishing substance and a curing substance surrounding the micro-encapsulated fire extinguishing substance.

In the fire extinguishing system with an immediate fire extinguisher according to the invention, the fire extinguishing substance of the immediate fire extinguisher of the spot-fire extinguishing system may be micro-encapsulated Freon 114B2, and the micro-encapsulated Freon 114B2 may be coated with a pentaphthalic enamel mixture as the curing substance.

In the fire extinguishing system with an immediate fire extinguisher according to the invention, the fire extinguishing substance of the immediate fire extinguisher of the spot-fire extinguishing system may be micro-encapsulated dibromoethane, and the micro-encapsulated dibromoethane may be coated with a pentaphthalic enamel mixture as the curing substance.

In the fire extinguishing system with an immediate fire extinguisher according to the invention, the immediate fire extinguisher may be produced in a shape of a flexible plate, may have an adhesive applied on one surface thereof, and may be attached to a site on which immediate fire extinguishing needs to be performed.

In the fire extinguishing system with an immediate fire extinguisher according to the invention, the immediate fire extinguisher may be installed at a position around a switchboard, a panelboard, a server rack, a fuse box, a power strip, a flue, a cabinet, a safe, a ventilation fan, an outdoor unit, and a motor.

In the fire extinguishing system with an immediate fire extinguisher according to the invention, the micro-encapsulated fire extinguishing substance may collapse at a temperature of 100° C. and performs extinguishing work.

According to the invention, there is provided a method using a fire extinguishing system that includes: a wide area fire extinguishing system configured to have a main control system, a fire detecting unit connected to the main control system, a communication unit, and a wide-fire extinguishing unit that extinguishes a wide-spread fire in response to an instruction from the main control system; and a spot-fire extinguishing system configured to have an RF communication module as a third communication module for communicating with the main control system, a temperature sensor, and the immediate fire extinguisher that performs immediate extinguishing of a fire, in which the main control system has a central processing unit that manages the entire fire extinguishing system, a telephone communication and internet communication module as a first communication module for communicating with the outside, and an RF module as a second communication module for communicating with the third communication module of the spot-fire extinguishing system, the method including: installing the spot-fire extinguishing system configured to have the third communication module for communicating with the second communication module of the main control system of the wide area fire extinguishing system, the immediate fire extinguisher, and a second fire detecting unit at a position needing to be protected from a fire such as a power strip, a switchboard, a panelboard, a server rack, a fuse box, a flue, a cabinet, a ventilation fan, or an outdoor unit of an air conditioner; and assigning a unique ID to each third communication module of each spot-fire extinguishing system and distinguishing between multiple spot-fire extinguishing systems.

In the method using a fire extinguishing system with an immediate fire extinguisher according to the invention, when a fire occurs at a site at which the spot-fire extinguishing system is installed, the immediate fire extinguisher of the spot-fire extinguishing system may operate to perform a fire extinguishing function, and simultaneously, the occurrence of fire and a primary fire extinguishing event may be notified to the main control system by communication of a temperature rise detected by the second fire detecting unit and a temperature drop due to putting out of the fire by the immediate fire extinguisher, the communication being performed by the third communication module with the second communication module of the wide area fire extinguishing system.

In the method using a fire extinguishing system according to the invention, the central processing unit of the main control system of the wide area fire extinguishing system may perform notification of the occurrence and a position of a small-scale fire and the putting-out of the fire through the first communication module to a predetermined telephone number, a user and a fire station by a telephone message or an SNS message and may request a site inspection.

In the method using a fire extinguishing system according to the invention, when immediate fire extinguishing is not smoothly performed by the immediate fire extinguisher, a small ember may remain at a site of the fire and cause re-ignition of the fire. When the small ember grows to a small-scale fire, the central processing unit of the main control system may check a rise in temperature with the second fire detecting unit and check that the immediate fire extinguisher is already used, then, may operate the wide-fire extinguishing unit and may simultaneously notify the user and the fire station of the re-ignition of the fire and request putting-out of the fire by a telephone message or an SNS message.

### BRIEF DESCRIPTION OF THE DRAWINGS

FIG. 1 is a diagram schematically illustrating a fire extinguishing system with an immediate fire extinguisher according to the invention;

FIGS. 2A and 2B are diagrams schematically illustrating the immediate fire extinguisher according to the invention;

FIG. 3A is a photograph illustrating an actual product of the immediate fire extinguisher, and FIG. 3B is a zoomed-in photograph illustrating a state of a micro-encapsulated fire extinguishing substance and a curing substance;

FIG. 4 is a photograph illustrating a state where the immediate fire extinguisher is applied to an electrical power strip; and

FIG. 5 is a flowchart schematically illustrating a method using the fire extinguishing system according to the invention.

### DETAILED DESCRIPTION OF EXEMPLARY EMBODIMENTS

Hereinafter, embodiments according to the invention will be described in detail with reference to the accompanying drawings. Configurations of the invention and operation and effects according thereto will be clearly understood through the following detailed description. Prior to the detailed description of the invention, note that the same reference numbers are assigned to the same configurational elements as much as possible even when the configurational elements are illustrated on different drawings and a known configuration is not described in detail when being considered to obscure the gist of the invention.

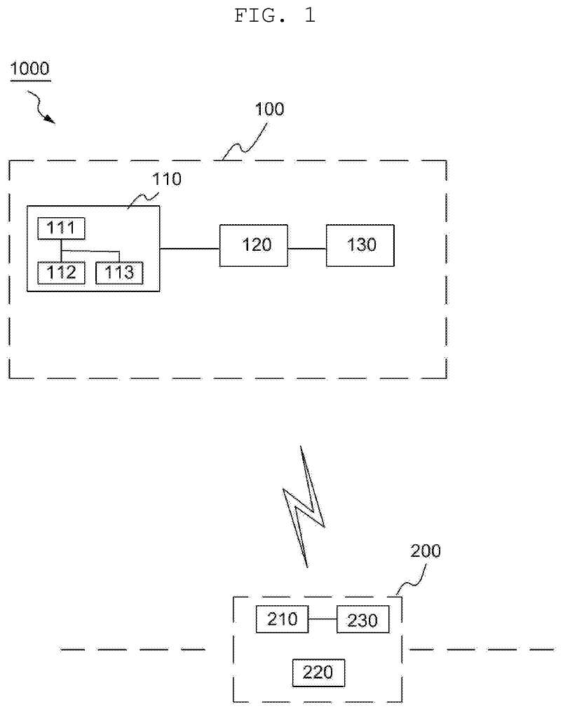

FIG. 1 is a diagram schematically illustrating a fire extinguishing system with an immediate fire extinguisher according to the invention.

As illustrated in FIG. 1, a fire extinguishing system 1000 with an immediate fire extinguisher according to the invention is configured to include a wide area fire extinguishing system 100 and a spot-fire extinguishing system 200.

The wide area fire extinguishing system is configured to have a main control system 110, a first fire detecting unit 120 that detects a fire, and a wide-fire extinguishing unit 130 that performs a fire extinguishing function when a fire occurs.

The spot-fire extinguishing system 200 is configured to have a third communication module 210 for communicating with the wide area fire extinguishing system, an immediate fire extinguisher 220, and a second fire detecting unit 230 that is installed in the vicinity of the immediate fire extinguisher.

The main control system 110 controls the entire fire extinguishing system with an immediate fire extinguisher system, and includes a central processing unit 111 that controls the entire system, a first communication module 112 for communicating with the outside through a wired telephone call and internet communication, and a second communication module 113 for communicating with the spot-fire extinguishing system.

The first communication module 112 is a data communication module through which telephone communication and internet communication can be performed, and the data communication module is connected to external data communication. The first communication module communicates with a mobile phone of a user, mobile phones of people who resides at a place where the fire extinguishing system is installed, and a fire station.

The second communication module 113 and the third communication module 210 are near-field communication module and can use Bluetooth, Wi-Fi, or Zigbee as a communication method, but it is desirable to use Bluetooth which can be operated with low power consumption and multi-channel communication.

The second communication module 113 can be provided at one position in the main control system, but multiple second communication modules can be arranged at multiple positions separated from the main control system due to a communicable distance of the second communication modules. In other words, when a space, in which the fire extinguishing system is installed, is broad or is a multi-story building, multiple second communication modules can be installed suitably for the communication distance.

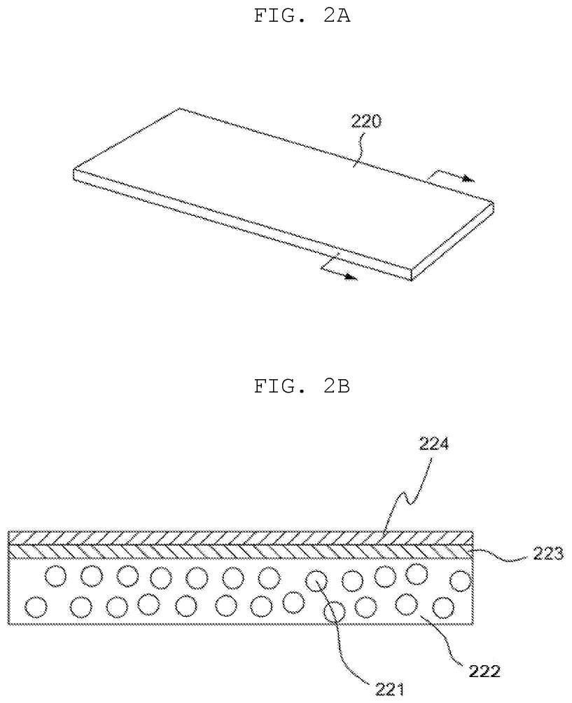

FIGS. 2A and 2B are diagrams schematically illustrating the immediate fire extinguisher 220 according to the invention.

As illustrated in FIGS. 2A and 2B, the immediate fire extinguisher 220 is formed in a shape of a sheet and is produced as follows. A fire extinguishing substance 221 is micro-encapsulated and, then, the micro-encapsulated fire extinguishing substance is coated with a predetermined curing substance 222. More specifically, the sheet-shaped immediate fire extinguisher is obtained by coating micro-encapsulated Freon 114B2 with a pentaphthalic enamel mixture as the curing substance or by coating micro-encapsulated dibromoethane with a pentaphthalic enamel mixture. An adhesive 223 is applied on one surface of the immediate fire extinguisher formed as described above, and an adhesion preventive sheet 224 is attached on the adhesive so as to prevent any attachment when the immediate fire extinguisher is not in use.

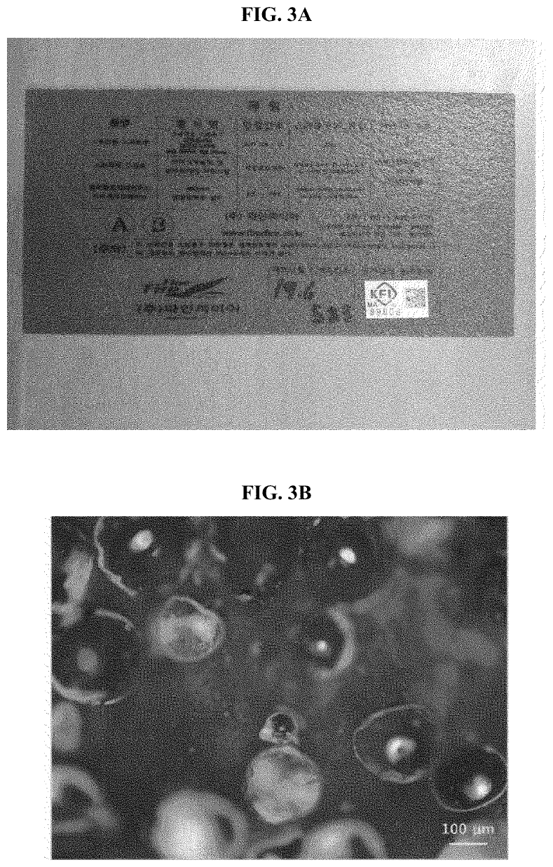

FIG. 3A is a photograph illustrating an actual product of the immediate fire extinguisher, and FIG. 3B is a zoomed-in photograph illustrating a state of the micro-encapsulated fire extinguishing substance and the curing substance. As illustrated in FIG. 3B, the micro-encapsulated fire extinguishing substance 221 is dispersed between the curing substance 222.

A method for using the immediate fire extinguisher configured as described above is as follows. The immediate fire extinguisher 220 is cut to have a required size and, then, is attached to a place which needs the immediate fire extinguisher after the adhesion preventive sheet 224 is removed.

An operation temperature of the immediate fire extinguisher according to the invention is about 100° C. The micro-encapsulated fire extinguishing substance is released at a temperature of about 100° C., and the curing substance is softened such that a fire extinguishing operation progresses. In other words, when a fire occurs due to an electrical spark in an apparatus to which the immediate fire extinguisher is attached, a temperature in the vicinity of a fire location rises to a temperature above 100° C., and thus the micro-encapsulated fire extinguishing substance of the immediate fire extinguisher collapses and is released into the atmosphere to immediately put out the fire.

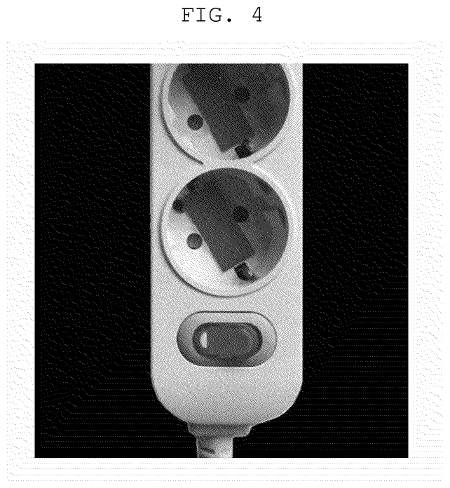

FIG. 4 is a photograph illustrating a state where the immediate fire extinguisher 220 is applied to an electrical power strip.

In general, in order to supply electricity to many electric or electronic units, plugs of the electric or electronic units are inserted into power supply holes of the power strip. In this state, when electrical contact or connection between the electrical power strip and the plugs loosens, overheating can occur at a contact or connection portion due to a rapid increase in electrical resistance, or overheating can occur when overcurrent greater than a current allowable by the power strip is supplied to the electric or electronic unit, and thereby a fire can occur in the power strip. When the fire occurs as described above, and a person is present around, the fire can be immediately extinguished. However, when a person is not present around, the fire can develop into a large-scale fire.

In order to solve such a problem, the immediate fire extinguisher of the invention is used. As illustrated in FIG. 4, the immediate fire extinguisher 220 according to the invention is cut to have a proper size and, then, is attached at a proper position of the power strip, for example, at a position between the power supply holes into which a plug is inserted.

In a state where the immediate fire extinguisher according to the invention is attached to the power strip as described above, when a fire occurs due to defective electrical contact between power supply of the power strip and the plug of the electric or electronic unit, a temperature in the vicinity of the fire rises to a temperature above 100° C. in a moment, the micro-encapsulated fire extinguishing substance of the immediate fire extinguisher collapses and is released depending on the temperature, and thereby immediate fire extinguishing proceeds.

The immediate fire extinguisher according to the invention is used at a small-sized site of a switchboard, a panelboard, a server rack, a fuse box, a flue, a cabinet, a ventilation fan, an outdoor unit of an air conditioner, or the like with a risk of fire.

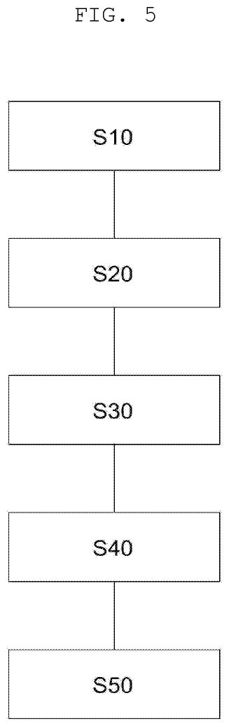

A method using the fire extinguishing system with the immediate fire extinguisher according to the invention will be described with reference to FIG. 5.

First, the spot-fire extinguishing system 200 configured to have the third communication module 210 for communicating with the second communication module 113 of the main control system 110 of the wide area fire extinguishing system 100, the immediate fire extinguisher 220, and the second fire detecting unit 230 is installed at a position needing to be protected from a fire such as a power strip, a switchboard, a panelboard, a server rack, a fuse box, a flue, a cabinet, a ventilation fan, an outdoor unit of an air conditioner, or the like (S10).

Here, since multiple spot-fire extinguishing systems 200 can be installed, for example, on respective floors of a predetermined building, on multiple power strips, on multiple switchboards, or the like, a unique ID is assigned to each third communication module 210 of each spot-fire extinguishing system (S20) such that the multiple spot-fire extinguishing systems 200 can be identified.

In this state, when a fire occurs at a site at which the spot-fire extinguishing system 200 is installed, the immediate fire extinguisher 220 of the spot-fire extinguishing system 200 operates to perform a fire extinguishing function, and simultaneously, the occurrence of fire and a primary fire extinguishing event are notified to the main control system by communication of a temperature rise detected by the second fire detecting unit 230 and a temperature drop due to putting out of the fire by the immediate fire extinguisher, the communication being performed by the third communication module 210 with the second communication module 113 of the wide area fire extinguishing system 100 (S30).

Then, the central processing unit 111 of the main control system 110 of the wide area fire extinguishing system 100 performs notification of the occurrence and a position of a small-scale fire and the putting-out of the fire through the first communication module 112 to a predetermined telephone number, a user (landlord, building manager, office worker, or the like) and a fire station by a telephone message or an SNS message and requests a site inspection (S40). The position of the fire can be checked because the unique ID is assigned to the third communication module. In other words, the accurate position of the fire can be known with the unique ID of the third communication module.

However, when immediate fire extinguishing is not smoothly performed by the immediate fire extinguisher 220, a small ember can remain at a site of the fire and can cause re-ignition of the fire. When the small ember grows to a small-scale fire again, the central processing unit 111 of the main control system 110 checks a rise in temperature with the second fire detecting unit and checks that the immediate fire extinguisher is already used, then, operates the wide-fire extinguishing unit 130, and, simultaneously, notifies the user and the fire station of the re-ignition of the fire and requests putting-out of the fire by a telephone message or an SNS message (S50).

Then, the user or staff of the fire station visits the site, checks a state of the occurrence and putting-out of the fire and, then, performs fire inspection.

As described above, the fire extinguishing system with an immediate fire extinguisher and the method using the fire extinguishing system according to the invention enables putting out of a fire without significant damage by immediately putting out the small-scale fire and simultaneously notifying the user or the fire station of the fire and enables the user or the fire station to accurately know the spot of a small-scale fire when the fire occurs by assigning the unique ID to the third communication module of the spot-fire extinguishing system. In particular, in a case of a place in which multiple power strips are used or a building with places at which multiple server racks are used, it is possible to quickly cope with a fire and significantly reduce monetary damage.

According to the invention, the immediate fire extinguisher is installed around the power strip, the switchboard, the panelboard, the power socket, the outdoor unit, the ventilation fan, and the motor, and thereby it is easy to initially put out a fire due to an electrical spark, and simultaneously, the user and the fire station is notified of a place where the fire occurs with accuracy in real time. In this manner, a large-scale fire is prevented in advance, and thereby effects of obtaining monetary saving and improving efficiency of fire checking are achieved.

As described above, the invention is described by focusing on the embodiment; however, the embodiment is provided only as an example, and the following has to be understood. It is possible for a person with ordinary skill in the technical field of the invention to perform various modifications on the invention and to embody additional embodiments similar to the modifications within a scope of the following claims.

What is claimed is:

1. A fire extinguishing system comprising:
a wide area fire extinguishing system configured to have a main control system, a fire detecting unit connected to the main control system, a communication unit, and a wide-fire extinguishing unit that extinguishes a wide-spread fire in response to an instruction from the main control system; and
a spot-fire extinguishing system configured to have a radio frequency (RF) communication module as a third communication module for communicating with the main control system, a temperature sensor, and an immediate fire extinguisher that performs immediate extinguishing of a fire.

2. The fire extinguishing system of claim 1, wherein the wide-fire extinguishing unit is a sprinkler.

3. The fire extinguishing system of claim 1, wherein the main control system has a central processing unit that manages the entire fire extinguishing system, a telephone communication and internet communication module as a first communication module for communicating with the outside, and an RF module as a second communication module for communicating with the third communication module of the spot-fire extinguishing system.

4. The fire extinguishing system of claim 3, wherein the wide-fire extinguishing unit has a gas fire extinguisher; and
the fire detecting unit has a temperature sensor and a smoke sensor.

5. The fire extinguishing system of claim 4, wherein the spot-fire extinguishing system is formed in a sheet-shaped patch and is made of a micro-encapsulated fire extinguishing substance and a curing substance surrounding the micro-encapsulated fire extinguishing substance.

6. The fire extinguishing system of claim 5, wherein the fire extinguishing substance of the immediate fire extinguisher of the spot-fire extinguishing system is micro-encapsulated Freon 114B2, and the micro-encapsulated Freon 114B2 is coated with a pentaphthalic enamel mixture as the curing substance.

7. The fire extinguishing system of claim 5, wherein the fire extinguishing substance of the immediate fire extinguisher of the spot-fire extinguishing system is micro-encapsulated dibromoethane, and the micro-encapsulated dibromoethane is coated with a pentaphthalic enamel mixture as the curing substance.

8. The fire extinguishing system of claim 6, wherein the immediate fire extinguisher is produced in a shape of a flexible plate, has an adhesive applied on one surface thereof, and is attached to a site at which immediate fire extinguishing needs to be performed.

9. The fire extinguishing system of claim 7, wherein the immediate fire extinguisher is produced in a shape of a flexible plate, has an adhesive applied on one surface thereof, and is attached to a site at which immediate fire extinguishing needs to be performed.

10. The fire extinguishing system of claim 8, wherein a position at which the immediate fire extinguisher is installed is a position around a switchboard, a panelboard, a server rack, a fuse box, a power strip, a flue, a cabinet, a safe, a ventilation fan, an outdoor unit, and a motor.

11. The fire extinguishing system of claim 9, wherein a position at which the immediate fire extinguisher is installed is a position around a switchboard, a panelboard, a server rack, a fuse box, a power strip, a flue, a cabinet, a safe, a ventilation fan, an outdoor unit, and a motor.

12. The fire extinguishing system of claim 5, wherein the micro-encapsulated fire extinguishing substance collapses at a temperature of 100° C. and performs extinguishing work.

13. A method for utilizing a fire extinguishing system comprising a wide area fire extinguishing system configured to have a main control system, a fire detecting unit connected to the main control system, a communication unit, and a wide-fire extinguishing unit that extinguishes a wide-spread fire in response to an instruction from the main control system, and a spot-fire extinguishing system configured to have a radio frequency (RF) communication module as a third communication module for communicating with the main control system, a temperature sensor, and an immediate fire extinguisher that performs immediate extinguishing of a fire, in which the main control system has a central processing unit that manages the entire fire extinguishing system, a telephone communication and internet communication module as a first communication module for communicating with the outside, and an RF module as a second communication module for communicating with the third communication module of the spot-fire extinguishing system, the method comprising:
installing the spot-fire extinguishing system configured to have the third communication module for communicating with the second communication module of the main control system of the wide area fire extinguishing system, the immediate fire extinguisher, and a second fire detecting unit at a position needing to be protected such as a power strip, a switchboard, a panelboard, a server rack, a fuse box, a flue, a cabinet, a ventilation fan, or an outdoor unit of an air conditioner; and
assigning a unique ID to each third communication module of each spot-fire extinguishing system and distinguishing between multiple spot-fire extinguishing systems.

14. The method of claim 13, wherein, when a fire occurs at a site at which the spot-fire extinguishing system is installed, the immediate fire extinguisher of the spot-fire extinguishing system operates to perform a fire extinguishing function, and simultaneously the occurrence of fire and a primary fire extinguishing event are notified to the main control system by communication of a temperature rise detected by the second fire detecting unit and a temperature drop due to putting out of the fire by the immediate fire extinguisher, the communication being performed by the third communication module with the second communication module of the wide area fire extinguishing system.

15. The method of claim 14, wherein the central processing unit of the main control system of the wide area fire extinguishing system performs notification of the occurrence and a position of a small-scale fire and the putting-out of the fire through the first communication module to a predetermined telephone number, a user and a fire station by a telephone message or an SNS message and requests a site inspection.

16. The method of claim 15, wherein, when immediate fire extinguishing is not smoothly performed by the immediate fire extinguisher, a small ember remains at a site of the fire and causes re-ignition of the fire, and when the small ember grows to a small-scale fire, the central processing unit of the main control system checks a rise in temperature with the second fire detecting unit and checks that the immediate fire extinguisher is already used, then, operates the wide-fire extinguishing unit and simultaneously notifies the user and the fire station of the re-ignition of the fire and requests putting-out of the fire by a telephone message or an SNS message.
